(19) United States
(12) Patent Application Publication
(10) Pub. No.: US 2012/0115071 A1
(43) Pub. Date: May 10, 2012

(54) SYSTEM FOR CONVERTING ENERGY WITH AN ENHANCED ELECTRIC FIELD

(75) Inventors: Jean-Marc Fleury, Saint Amand Les Eaux (FR); Gauthier Lasou, Bures-sur-Yvette (FR); Philippe Alonso, Montmorency (FR)

(73) Assignee: Chantal Chapel et al., Paris (FR)

(21) Appl. No.: 13/382,539

(22) PCT Filed: Jun. 25, 2010
(86) PCT No.: PCT/FR10/51325

§ 371 Date: Jan. 6, 2012

(30) Foreign Application Priority Data
Jul. 8, 2009 (FR) 0954726

(51) Int. Cl. H01M 4/02; C25B 15/00; H01M 4/583; H01M 4/86; H01M 10/02; H01M 10/00; C25B 9/00; H01M 4/38; B82Y 40/00

(52) U.S. Cl. 429/523; 204/242; 205/334; 429/209; 429/231.8; 429/223; 429/221; 429/50; 977/840

(57) ABSTRACT

An energy conversion system, including a first and second electrodes with an inter-electrode gap therebetween that includes a functional medium, wherein the first electrode is made of at least one elongate electrically conductive media having a total length L, a curved cross-section, and a radius R, and arranged into a sturdy assembly structure having a more or less open pattern, capable of having the same electric potential at any location and thus of constituting said first electrode. Where R is lower than 40×10-6 m the inter-electrode gap has a thickness of between 1×10-9 m and 5×10-3 m, the total length L of the electrically conductive media of the first electrode is greater than 1×103 m, and the ratio L/R is greater than 106 such that the first electrode generates a significant increase in the electric field perceived by the second electrode.

### FIELD

The invention relates to energy conversion and more specifically to an energy conversion system having an enhanced electric field around at least one of its two electrodes. The invention also relates to various energy conversion devices prepared with such a system. The invention also relates to the application of an electrically conductive means for producing at least one of the two electrodes of such a system, generating a significant increase in the electric field received by the other electrode.

Energy conversion systems comprising a first electrode, a second electrode and an inter-electrode gap comprising a functional medium such as an electrolyte or a dielectric are known. The effectiveness of such systems depends in particular on two parameters: the efficiency of the system and its cost. Their optimization is usually based on an empirical approach consisting in adjusting the various parameters defining the system.

The specialized literature (Techniques de l'ingénieur, Encyclopedia of Electrochemistry, Ed. Wiley 2007; Handbook of Electrochemistry, 1st Ed., Cynthia G. Zoski, Ed. Elsevier 2007) teaches the various strategies for optimizing the efficiency of an electrochemical reactor and also the overall associated costs. In particular, it is indicated therein that the important parameters are mainly the inter-electrode gap, the catalyst and the electrolyte for aspects associated with enhancing the efficiency on the one hand, and the increase in the electrode surface area and the electrode surface area to volume ratio for aspects associated with investment costs (increase in the electrical current hence in the production efficiency for a given volume) on the other hand.

Document GB-A-2018826 teaches that an electrode should offer the largest possible surface area to the electrolyte, which can be achieved either by providing that the electrode surface has microroughnesses or by providing that the electrode assembly structure procures such a high surface area.

Document U.S. Pat. No. 4,046,664 also teaches that the efficiency of an electrochemical reactor depends on the surface area of the working electrode, which must be maximized and completely exposed to the electrolyte. The document describes, for this purpose, a working electrode consisting of a tow made from a large number of similar filaments, having the same length, made from copper or metal-coated carbon fibers, arranged in parallel to one another, suspended by its upper end from an assembly and electrical connection member capable of being in electrical contact with all the filaments of the tow. The cross section of the filaments is as small as possible in order to perform two functions: to increase the contact area of the working electrode with the electrolyte and to allow the passage of the electrolyte through the filament tow. The reactor comprises a working electrode as described above, placed in a nonconductive guide member, and a conventional counter electrode. The filaments of the working electrode tend to be arranged individually in the electrolyte, because of the electrolyte flow around the filaments. The filaments have a circular cross section to prevent them from being entangled with one another and thereby preventing the passage of the electrolyte.

Document U.S. 4,108,755 describes a reactor of the type described in document U.S. 4,046,664, wherein the working electrode is a tow made from a large number of metal filaments.

Document U.S. Pat. No. 5,294,319 describes an electrochemical reactor in which at least one electrode is made from a substrate of fibers or filaments which have a unit diameter smaller than 254×10⁻⁶ m (10 mils), which are also in the form of tows or strips, said substrate then being subjected to successive operations to produce the final electrode (catalyst deposition, annealing, compression).

Document U.S. Pat. No. 4,108,754 describes a reactor deriving from document U.S. 4,046,664, in which the working electrode is placed in a recess comprising an electrolyte inlet in the upper part and electrolyte discharge orifices in the lower part. The working electrode is made from a large number of carbon fibers closely assembled and pressed together, making electrical contact with each other. As many as 5000 to 10 000 fibers may be provided, each having a diameter of between 5 and 15 microns (5×10⁻⁶ m to 15×10⁻⁶ m), this range being purely indicative because it is taught that other diameters are feasible.

Document U.S. Pat. No. 4,108,757 describes an electrode for a reactor of the type described in document U.S. Pat. No. 4,108,754, comprising carbon fibers and fiber-joining means placed over at least a limited portion of the length of the fibers.

In consequence, the teaching of these various documents only relates to the surface of the desired working electrode, maximized and exposed to the electrolyte. No electrostatic benefit is really drawn from the electrode microstructure, particularly from the radius of curvature of the filaments, since the use of tows composed of several filaments is equivalent, in terms of structure for the electric field, to a filament whose diameter is approximately the diameter of a unit filament multiplied by the square root of the number of filaments in the tow.

Furthermore, document U.S. Pat. No. 4,337,138 poses the problem of enhancing the efficiency of energy conversion systems. For this purpose, this document describes an electrode comprising an electrically conductive collector and a working surface containing a plurality of conductive islands in a nonconductive matrix.

Document U.S. Pat. No. 4,369,104 addresses the same problem and, for this purpose, describes an improved graphite composite electrode in which graphite fibers having a diameter smaller than 30 microns (30×10⁻⁶ m) are dispersed in a thermoplastic resin matrix, and are arranged parallel to one another and perpendicular to the matrix surface.

In these two constructions, no benefit is drawn from the conductive parts embedded in the matrix.

Document WO 2008/012403 also addresses the problem of efficiency enhancement and describes an electrolysis device comprising a cathode compartment, an anode compartment, and an element linking these two compartments, the cathode compartment containing at least one weak acid. Such a device requires the use of ion exchange membranes, making its cost prohibitive.

Document US-A-2008/027787 addresses the same problem and describes a porous electrode, with nickel nanoparticles in suspension in the voids. Such a construction is complex and costly.

In consequence, the teaching of this second series of documents points to the advantage of increasing the efficiency of energy conversion systems and the fact that this problem has many different technical solutions. However, with a view to industrial operation, such technical solutions must be feasible and operable under acceptable cost conditions, which does not appear to be the case in this context.

The problem underlying the invention is therefore to have an energy conversion system of the type comprising a first electrode, a second electrode and an inter-electrode gap comprising a functional medium such as an electrolyte or a dielectric, which is optimized in order to procure high efficiency at reasonable production cost at the industrial scale and reasonable operating costs, allowing commercial use.

It is the object of the invention to provide a solution to this problem, which solution is furthermore simple to implement, and also reproducible and reliable.

The invention is first and foremost based on the demonstration of an effect hitherto unidentified in the context of the invention, that an elongate electrically conductive means having a radius of curvature R smaller than 40×10⁻⁶ m (40 microns) arranged to constitute at least the first electrode of an energy conversion system further comprising a second electrode and an inter-electrode gap comprising a functional medium, is capable, at the nanometric to millimetric scale, of significantly increasing the electric field around the first electrode thereby constituted.

This effect is referred to here as the “corona effect”, by analogy with the conventional corona effect known in the case of electrical cables having a diameter of about a few centimeters, under high electrical voltage, about several tens of kilovolts.

In the present invention, the so-called “corona effect” is obtained with an electrically conductive means having a very small radius of curvature R—smaller than 40×10⁻⁶ m (40 microns)—and with an electrical voltage that is also very low compared to the known radius of curvature and voltage in the case of the conventional corona effect.

The invention is also based on the finding that such a first electrode combined with an inter-electrode gap having a thickness of between 1×10⁻⁹ m and 5×10⁻³ m (1 nanometer and 5 millimeters) is such that the second electrode is capable of perceiving the electric field enhanced thereby, so that the energy conversion system benefits from this “corona effect”.

The invention is also based on the finding that this “corona effect” which must exist without being measurable for low filament lengths, becomes advantageous in terms of effectiveness once the length of the constituent filament exceeds 10⁶ (one million) times its radius and preferably 2.5×10⁷ (25 million) times its radius.

The invention is also based on the finding that such a structure—first electrode and inter-electrode gap—combined with a structure of the first electrode such that its interfacial area is high, procures surprising results in terms of energy conversion efficiency.

The invention is also based on the finding that the abovementioned arrangements are of general scope and can be the subject of many different implementations offering a large number of applications.

According to a first aspect, the invention consists of an energy conversion system, comprising a first electrode, a second electrode, and an inter-electrode gap therebetween that comprises a functional medium, the first electrode being made of at least one elongate electrically conductive means having a total length L, a curved cross section, and a radius of curvature R, and arranged into a sturdy assembly structure having a more or less open pattern, capable of having the same electrical potential at any location and thus of constituting said first electrode. The energy conversion system according to the invention is characterized in that:
R is smaller than 40×10⁻⁶ m (40 microns),
the inter-electrode gap has a thickness of between 1×10⁻⁹ m and 5×10⁻³ m (1 nanometer and 5 millimeters),
the total length L of the at least one electrically conductive means of the first electrode is greater than 1×10³ m (1 kilometer), and
the L/R ratio is greater than 10⁶ (one million) such that the first electrode generates, at the nanometric to millimetric level, a significant increase in the electric field perceived by the second electrode.

According to a second aspect, the invention also relates to an energy conversion system, comprising a first electrode, a second electrode, and an inter-electrode gap therebetween that comprises a functional medium, the first electrode being made of at least one elongate electrically conductive means having a total length L, a curved cross section, and a radius of curvature R, and arranged in a sturdy assembly structure having a more or less open pattern, capable of having the same electrical potential at any location and thus of constituting said first electrode. This system is characterized in that
R is smaller than 50×10⁻⁶ m (50 microns),
the inter-electrode gap has a thickness of between 1×10⁻⁹ m and 2×10⁻² m (1 nanometer and 2 centimeters), and
the L/R ratio is higher than 3×10⁶ (three million) such that the first electrode (106, 306) generates, at the nanometric to millimetric level, a significant increase in the electric field perceived by the second electrode (107, 307).

According to feasible embodiments, the electrically conductive means of the first electrode consists of an electrical conductor or comprises an electrically insulating internal structure covered with an electrically conductive external structure, said external structure possibly being in the form of a layer.

According to one embodiment, the external structure is in the form of a layer.

According to one embodiment, the electrically conductive means of the first electrode is made from, or comprises, at least one material selected from the group comprising carbon, graphite, nickel or an alloy comprising nickel, steels and alloys comprising iron.

According to one embodiment, the electrically conductive means of the first electrode is self-supporting or non-self-supporting, the first electrode comprising a mechanical strength portion.

According to one embodiment, the electrically conductive means of the first electrode (106, 306) has the form of a filament, fiber, or point.

According to an embodiment, the assembly structure of the electrically conductive means of the first electrode is an unorganized bulk structure or an organized structure, in particular having the form of a sheet, plate, strip or coil.

According to one embodiment, the electrically conductive means of the first electrode is looped on itself in a closed circuit.

According to one embodiment, the electrically conductive means of the first electrode is not looped on itself and is in an open circuit.

According to a first embodiment, the conversion system comprises a first electrode and a second electrode having a symmetrical or pseudo-symmetrical structure. According to a second alternative embodiment, the conversion system comprises a first electrode and a second electrode having an asymmetrical structure.

The invention also relates to an energy conversion device including an energy conversion system according to the abovementioned first embodiment, consisting of a device for electrolysis, photolysis or electrosynthesis, for generating electricity by reverse electrolysis, for a fuel cell, an electric battery, or an ozone generator, or for electrodialysis.

The invention also relates to an energy conversion device including an energy conversion system according to the abovementioned second embodiment, consisting of a device such as a capacitor, discharge lamp, photovoltaic generator, solar cell with photoactive conductor.

The invention further relates to an application of an elongate electrically conductive means having a length L greater than 1×10³ m (1 kilometer) and a radius of curvature R smaller than 40×10⁻⁶ m (40 microns) such that the L/R ratio is higher than 10⁶ (one million), for constituting a first electrode of an energy conversion system further comprising a second electrode and an inter-electrode gap comprising a functional medium, the first electrode generating, at the nanometric to millimetric scale, a significant increase in the electric field.

The invention also relates to an application of an elongate electrically conductive means having a length L greater than 1×10³ m (1 kilometer) and a radius of curvature R smaller than 40×10⁻⁶ m (40 microns) such that the L/R ratio is higher than 10⁶ (one million), for constituting a first electrode of an energy conversion system further comprising a second electrode and an inter-electrode gap comprising a functional medium, the first electrode generating, at the nanometric to millimetric scale, a significant increase in the electric field perceived by the second electrode, the inter-electrode gap having a thickness of between 1×10⁻⁹ m and 5×10⁻³ m (1 nanometer and 5 millimeters).

The invention also relates to the application of the energy conversion system of the invention for producing nanometric to micrometric powders.

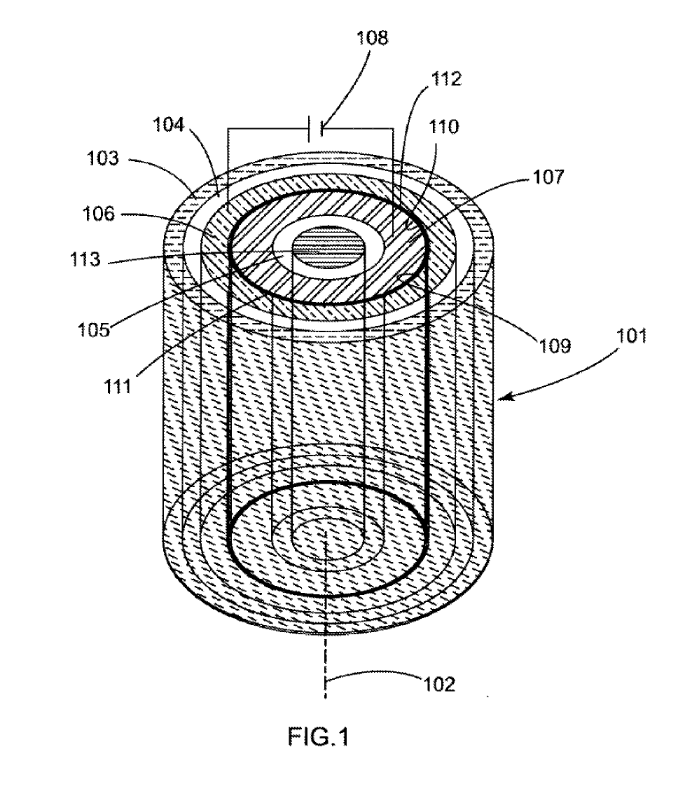

Various embodiments of the invention, which are nonlimiting, are now described in relation to the appended drawings, in which:
FIG. 1 is a perspective diagram of a first particular feasible embodiment of a device including an energy conversion system according to the invention, that is to say an electrolysis device, the first electrode and the second electrode of the system having a symmetrical or pseudo-symmetrical structure.

FIG. 1′ is a graph showing the variation in efficiency of the electrolysis device in percentage (y-axis) for all the experiments performed, as a function of the ratio of the length of the filament to its radius (x-axis).

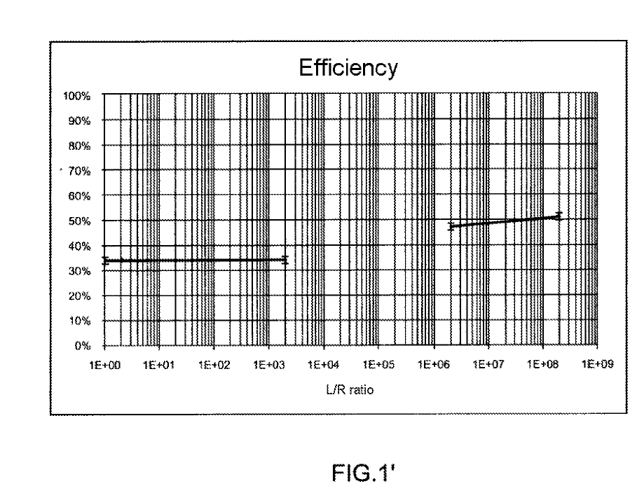

FIG. 2 is a perspective diagram of a second particular embodiment of the device including an energy conversion system according to the invention, that is to say a capacitor, the two electrodes also having an asymmetrical structure here.

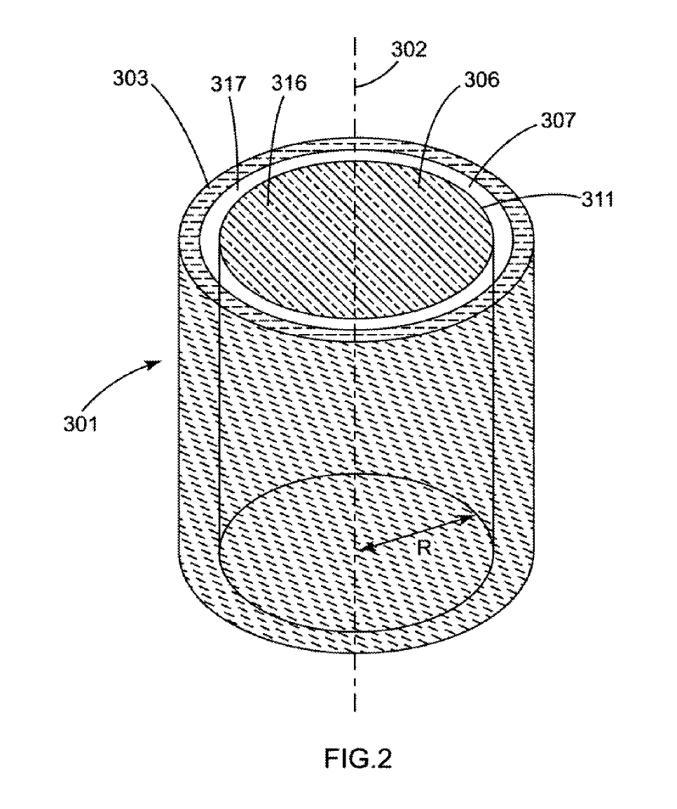

FIG. 3 is a micron-scale diagram showing a first feasible embodiment of an electrode of the energy conversion system in which the electrically conductive means is in the form of a fiber, with an unorganized bulk assembly structure.

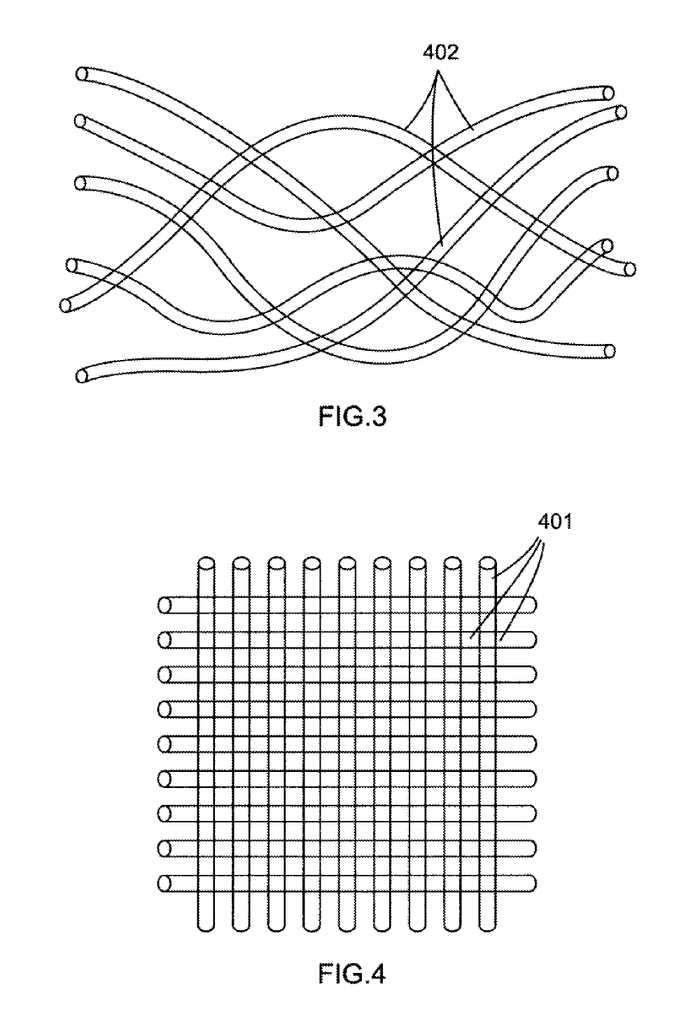

FIG. 4 is a micron-scale diagram showing a second feasible embodiment of an electrode of the energy conversion system in which the electrically conductive means is in the form of a filament, with an organized assembly structure such as a fabric or a network.

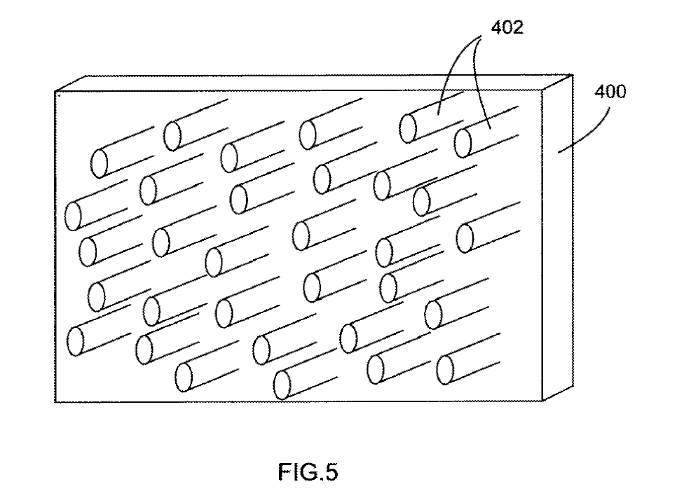

FIG. 5 is a micron-scale diagram showing a third feasible embodiment of an electrode of the energy conversion system in which the electrically conductive means is in the form of a point, in an assembly structure organized in a network.

Reference is now made more specially to FIG. 1 which shows an electrolysis device 101, having an axis of revolution 102.

This electrolysis device 101 comprises a hollow external chamber 103, having a cylindrical shape here.

The hollow external chamber 103 contains an anode compartment 104 and a cathode compartment 105. These two compartments 104, 105 have a generally cylindrical shape, coaxial with the axis 102. They are placed one inside the other, here the anode compartment 104 outwardly surrounds the cathode compartment 105.

The anode compartment 104 comprises an electrode forming an anode 106 and the cathode compartment 105 comprises an electrode forming a cathode 107.

A potential differential is applied at 108 between the anode 106 and the cathode 107.

The internal surface 109 of the anode 106 and the external surface 110 of the cathode 107 are positioned opposite one another and define an inter-electrode gap 111 therebetween.

A filter 112, placed in the inter-electrode gap 111, separates the anode 106 from the cathode 107 and allows the presence of an electrolyte between them. In the context of a test carried out, the electrolyte is municipal water (tap water), slightly ionized, and a passive system consisting of a cylindrical magnet 113 such as a NdFeB magnet, is placed at the center of the cathode compartment 105 provided for this purpose with a central void.

The anode 106 and the cathode 107, in the embodiment considered here, have an identical or similar structure, without necessarily having the same surface area, thereby serving to qualify this structure as symmetrical or pseudo-symmetrical.

According to a feasible embodiment, to form the anode 106 and the cathode 107, respectively, a structure is provided consisting of a filter having the general shape of a hollow cylinder with pores of 25×10⁻⁶ m (25 microns). Externally and internally with regard to this structure, steel wool having a small radius of curvature R of 9×10⁻⁶ m (9 microns) is medium-packed—with void content higher than 70%, the total length L of each steel wool electrode being 10×10³ m (10 kilometers).

The tests performed demonstrated that it is possible with such an electrolysis device 101 to dissociate the water molecule of the electrolyte, using very slightly ionized municipal water, at a voltage of about 0.8 to 1 V (0.8 to 1 volt), with a hydrogen production yield measured at 88%, the hydrogen collected being pure and containing neither carbon dioxide nor water vapor, and the device operating at ambient temperature.

The tests performed demonstrated that the yield could be raised to 97% by using saltwater as electrolyte, the system being devoid of the magnet 113 in this case.

The electrolysis device 101 described above is therefore characterized by its high efficiency.

This high efficiency appears to be explicable by a number of factors.

Firstly, an effect called “corona effect” here, resulting from the combination of an anode 106 and a cathode 107 prepared from an elongate electrically conductive means (steel wool fibers or filaments) having a length L of 1×10³ m (10 kilometers) and a very small radius of curvature R, smaller than 40×10⁻⁶ m (40 microns), such that the L/R ratio is higher than 10⁶ (1.1×10⁹ in this case) and an inter-electrode gap 111 having a low thickness of between 1×10⁻⁹ m and 5×10⁻³ m (1 nanometer and 1 millimeter), so that the electric field around an electrode, at the nanometer to millimeter scale, is significantly increased, and is perceivable by the other electrode.

Secondly, the structure of the anode 106 and of the cathode 107 is such that their interfacial area is high, which contributes in its turn to enhancing the efficiency of the system.

It should be stressed that steel wool is not inert to the functional medium consisting of municipal water (tap water). It is rapidly destroyed during the electrochemical operation of the reactor. Further tests were therefore performed with materials normally considered to be relatively inert, such as nickel. A decomposition of the nickel electrodes at the anode and at the cathode rapidly appeared, with the appearance of an oxidized compound of nickel in the form of a micron-sized powder.

The construction of an electrolyzer comprising a pure nickel fabric cathode and a gold anode also culminated in the decomposition of both electrodes, the nickel cathode having an appearance of a black powder whereas the gold anode was fragmented into gold microparticles.

In this series of tests, the strength of the “corona effect”, an electrostatic effect due to the increased electric field, was thus greater than the inertia of the material with regard to electrolysis.

Further experiments also demonstrated the absence of the creation of a passivation layer for zinc and aluminum electrodes, and the creation in the former case of a zinc oxide powder, in the second case of an aluminum oxide or hydroxide powder, having a diameter directly depending on the strength of the current applied to the electrolyzer terminals. For low currents, powder size measurements indicated the existence of a population having a sub-micron diameter.

Other tests were performed with an alternative embodiment of the electrolyzer.

According to this embodiment, a functional medium consisting of sodium silicate and sodium hydroxide was used, and measurements were also taken to demonstrate the direct effect of the radius of curvature and of the L/D ratio of a filament electrode.

An elementary electrolyzer was constructed in a cylindrical geometry, without any separating wall between the anode compartment and the cathode compartment (filter or membrane). The opposing surface area of each electrode was set at 30 cm², the electrical voltage was set at 2.5 V, the inter-electrode gap was set at 5×10⁻³ m (5 millimeters), the electrolyte consisted of 20% by weight of sodium silicate and 20% by weight of sodium hydroxide in deionized water, this electrolyte serving to obtain a high conductivity while guaranteeing the stability of the electrodes, even in the case of steel.

These parameters (particularly the maximum inter-electrode gap of 5 millimeters) were deliberately selected to guarantee the reproducibility of the experiments on the one hand, and to allow the measurement of wide differences in the hydrogen production efficiencies on the other hand. In fact, the reduction of the inter-electrode gap would have led to higher efficiencies for all the electrode structures, but the differences between these efficiencies would have been lower and therefore more difficult to measure and interpret. Since all of these parameters were constant, the variation concerned the structure of the electrode and, in particular, the radius of curvature and the total length of filament. The margins of error in the hydrogen production efficiency measurements were 3%. The experiments were conducted for several hundred hours.

The overall results are given in the table below:

| | | Inter- | Opposing | | | | Length/ | |
|---|---|---|---|---|---|---|---|---|
| | | electrode | surface | | | Filament | Radius | |
| Anode | Cathode | gap | areas | Electrolyte | Voltage | diameter | Ratio | Efficiency |
| steel | steel | 5 × 10⁻³ m | 30 cm³ | 20% sodium | 2.5 V | plate | 1 | 34% |
| | | | | silicate in | | | | |
| | | | | water and | | | | |
| | | | | 20% sodium | | | | |
| | | | | hydroxide | | | | |
| | | | | in water | | | | |
| steel | steel | 5 × 10⁻³ m | 30 cm³ | 20% sodium | 2.5 V | 1 × 10⁻³ m | 2000 | 34% |
| | | | | silicate in | | | | |
| | | | | water and | | | | |
| | | | | 20% sodium | | | | |
| | | | | hydroxide | | | | |
| | | | | in water | | | | |
| nickel | nickel | 5 × 10⁻³ m | 30 cm³ | 20% sodium | 2.5 V | 55 × 10⁻⁶ m | 2 000 000 | 47% |
| | | | | silicate in | | | | |
| | | | | water and | | | | |
| | | | | 20% sodium | | | | |
| | | | | hydroxide | | | | |
| | | | | in water | | | | |
| steel | steel | 5 × 10⁻³ m | 30 cm³ | 20% sodium | 2.5 V | 18 × 10⁻⁶ m | 200 000 000 | 51% |
| | | | | silicate in | | | | |
| | | | | water and | | | | |
| | | | | 20% sodium | | | | |
| | | | | hydroxide | | | | |
| | | | | in water | | | | |

The measured efficiency is the ratio of the energy contained in the hydrogen produced to the energy input by the electric power supply.

Thus, an efficiency of 34% was obtained with electrodes consisting of steel plates (no radius of curvature, L/R ratio of 1).

An identical efficiency of 34% (within the margin of error) was also measured using a steel filament having a diameter of 1 mm (L/R ratio about 2000).

Using a nickel fabric with filaments having a diameter of 55×10⁻⁶ m (55 microns), the measured efficiency was 47% (L/R ratio about 2 000 000).

With steel wool measuring 18×10⁻⁶ m (18 microns) in diameter, the efficiency proved to be 51% (L/R ratio about 200 000 000).

The graph in FIG. 1′ shows the variation in efficiency in percentage (y-axis) for all the experiments performed, as a function of the ratio of the length of the filament to its radius (x-axis).

A final experiment was performed with an electrolysis cell intended for producing hydrogen, comprising a cathode prepared from a nickel fabric, a stainless steel fabric anode, both electrodes having an opposing surface area of 1 dm² (1 square decimeter) and with a gap of 5 mm (5 millimeters) between them. The electrolyte consisted of 30% potassium hydroxide and 20% potassium silicate in deionized water. The efficiency measured, at ambient temperature and pressure, for a voltage of 1.9 V under these non-optimal conditions, proved to be 88%. This type of device, which incurs very low production and operating costs, appears to be feasible for commercial use.

Instead of an electrolysis device, the energy conversion system may also, still with a first electrode and a second electrode having a symmetrical or pseudo-symmetrical structure, be suitable for preparing an electric generator. The device is structurally identical or similar to the electrolysis device. In this case, hydrogen is injected via the bottom of the device into the anode compartment and air is injected via the bottom into the cathode compartment, in the form of microbubbles. A reverse electrolysis reaction serves to generate electrical current. Such a device allows a reversible reaction: electrolysis or generation of electrical current.

Other devices with a symmetrical or pseudo-symmetrical structure of the electrodes are feasible, such as a photolysis device, electrosynthesis device, fuel cell, electric battery, ozone generator, electrodialyzer.

The embodiment in FIG. 3 is now described in detail.

Instead of having a symmetrical or pseudo-symmetrical structure as in the abovementioned embodiments, the electrode may also have an asymmetrical structure, as in the case of a capacitor 301 corresponding to the embodiment in FIG. 3.

As previously, the capacitor 301 comprises a hollow external chamber 303, of cylindrical shape here and having an axis 302.

The hollow external chamber 303 contains a first electrode 306 and a second electrode 307.

The first electrode 306 is made from a copper wire having a length of 1×10³ m (1 kilometer) and a diameter (2×R) of 50×10⁻⁶ m (50 microns), looped on itself, placed on the outer face of a cylindrical support, which is itself placed in the hollow external chamber 303.

The second electrode 307 is an electrolyte placed in the space between a dielectric 311 in the form of a layer externally covering the conductive wire of the first electrode 306 and the hollow external chamber 303.

The dielectric 311 thereby fills the space between the electrodes 306 and 307.

The dielectric 311 here is polyurethane.

Electrical connectors 316 and 317 are connected on the one hand to the electrically conductive wire of the first electrode 306 and the electrolyte forming the second electrode 307.

With the dielectric constant of polyurethane of about 2, the calculated theoretical capacitance of the capacitor 301 is 3 μF (3 microfarads). With the choice of an aqueous saturated solution of NaCl, the capacitance is first 25 μF (25 microfarads), and then increases to reach 120 μF (120 microfarads) and then stabilizes.

Obviously, these capacitance values are purely indicative.

The first electrode 306 is of a type similar to the anodes 106 and 206 previously described, whereas the second electrode 307, an electrolyte here, has a different structure both from the first electrode 306 and from the previously described cathode 107, so that the structure of the electrodes of the capacitor 301 can justifiably be qualified as asymmetrical.

According to an alternative, the first electrode 306 is prepared not with an enameled copper wire, but with an aluminum wire having a diameter of (2×R) of 40×10⁻⁶ m (40 microns) and a length of about 600 m (600 meters).

An oxidation layer is created on the aluminum wire depending on the maximum desired service voltage, for example 150×10⁻⁹ m (150 nanometers) for a voltage of 100 V (100 volts).

The surface area of the electrode thus prepared is about 145×10⁻⁴ m² (145 square centimeters). The theoretical capacitance of such a capacitor is 9 μF (9 microfarads), but its real capacitance, considering the “corona” enhancing effect, is higher.

Other devices can be considered using an asymmetrical structure of electrodes, such as a discharge lamp, a photovoltaic generator, a solar cell with a photoactive conductor.

In all cases, these devices are based on energy conversion systems comprising a first electrode (106, 306), a second electrode (107, 307) and, therebetween, an inter-electrode gap (111, 311) comprising a functional medium.

One of the electrodes—in this case the first electrode or anode—in the case of an asymmetrical structure, or both electrodes, in the case of a symmetrical or pseudo-symmetrical structure, is prepared using at least one electrically conductive means, which is elongate and has a total length L, a curved cross section and a radius of curvature R, arranged in a sturdy assembly structure, with a more or less open pattern, capable of having the same electric potential at any location and thus of constituting said first electrode or said first electrode and second electrode.

According to the invention, the radius of curvature R is smaller than 40×10⁻⁶ m (40 microns) and the length L is such that the L/R ratio is higher than 10⁶ (one million), preferably higher than 2.5×10⁷ (25 million).

In combination, the inter-electrode gap (111, 311) has a thickness (distance between the two electrodes) of between 1×10⁻⁹ m and 5×10⁻³ m (1 nanometer and 5 millimeters).

A significant increase in the electric field is thereby created, capable of being perceived by the opposite electrode.

The electrically conductive means of the electrode or electrodes concerned may be the subject of various alternative embodiments.

In a first embodiment, the electrically conductive means consists of an electrical conductor.

In a second embodiment, the electrically conductive means comprises an internal electrically insulating structure covered with an external electrically conductive structure. Such an external structure is typically in the form of a layer.

As it results from the above description, the electrically conductive means comprises at least one material selected for being adapted to the functional medium for the application considered (electrolysis, photolysis, powder production). For example, and without this list being limiting, the material may be carbon, graphite, nickel or an alloy comprising nickel, stainless steel or a photosensitive material. In general, the conductive means is not, per se, capable of having the overall mechanical strength required. Thus, in one embodiment, it is provided for the electrically conductive means to comprise a mechanical strength portion and an electrically conductive portion. In another embodiment, the electrically conductive means is supported by a separate mechanical strength means 400, such as a plate, a strip, a coil, etc.

In the embodiments described above, the electrically conductive means is in the form of a filament or fiber 401, as also shown in FIGS. 3 and 4. This embodiment is not exclusive of others, for example a point shape 402, as shown in FIG. 5. Such points 402 may project from a mechanical strength means 400 such as a plate.

Reference is now made more specifically to FIGS. 3 to 5, which show the assembly structure of the electrically conductive means.

In the embodiment shown in FIG. 3, the assembly structure of the electrically conductive means is unorganized, in bulk.

In the embodiments shown in FIGS. 4 and 5, the assembly structure of the electrically conductive means is organized. It is a sort of fabric (FIG. 4), or a flat coil or even a network of points (FIG. 5).

As required, the electrically conductive means is looped on itself in a closed circuit, or not looped, in this case in open circuit. In all cases, the conductor has the same electric potential at all locations.

As resulting from the above description, the invention may also be seen as the application of a conductive means as described above for the constitution of at least one, and possibly the two, electrodes (106, 107, 306) of an energy conversion system, procuring a significant increase in the electric field at the nanometric to millimetric scale.

This feature, combined with an inter-electrode gap (111, 311) having a thickness of between 1×10⁻⁹ m and 5×10⁻³ m (1 nanometer and 5 millimeters) is such that this effect of significant increase in the electric field is perceivable by the opposite electrode.

An energy conversion system can thereby be obtained, of the type comprising a first electrode, a second electrode and an inter-electrode gap comprising a functional medium such as an electrolyte or a dielectric, optimized so as to procure high efficiency at reasonable industrial scale production cost and reasonable operating cost, allowing commercial use.

An additional embodiment of the invention (not shown) is described below as a nonlimiting example.

According to this embodiment, the energy conversion system comprises a first electrode made from an elongate conductive steel wire, having a total length L, with a curved cross section and a radius of curvature of 45×10⁻⁶ m (45 microns).

The energy conversion system further comprises a second electrode and, therebetween, an inter-electrode gap of 1.5 centimeters comprising a functional medium composed of 20% by weight of sodium silicate and 10% by weight of sodium hydroxide in deionized water.

Furthermore, according to this embodiment, the L/R ratio is 5×10⁶ (5 million) which serves to obtain, at the nanometric to millimetric scale, a significant increase in the electric field perceived by the second electrode.

1. An energy conversion system, comprising a first electrode, a second electrode, and an inter-electrode gap therebetween that comprises a functional medium, the first electrode being made of at least one elongate electrically conductive means having a total length L, a curved cross section, and a radius of curvature R, and arranged into a sturdy assembly structure having a more or less open pattern, capable of having the same electrical potential at any location and thus of constituting said first electrode,
wherein:
R is smaller than 40×10⁻⁶ m (40 microns),
the inter-electrode gap has a thickness of between 1×10⁻⁹ m and 5×10⁻³ m (1 nanometer and 5 millimeters),
the total length L of the at least one electrically conductive means of the first electrode is greater than 1×10³ m (1 kilometer), and
the L/R ratio is greater than 10⁶ (one million) such that the first electrode generates, at the nanometric to millimetric level, a significant increase in the electric field perceived by the second electrode (107, 307)

2. The energy conversion system as claimed in claim 1, characterized in that the electrically conductive means of the first electrode consists of an electrical conductor or comprises an electrically insulating internal structure covered with an electrically conductive external structure.

3. The energy conversion system as claimed in claim 2, characterized in that the external structure is in the form of a layer.

4. The energy conversion system as claimed in claim 1, characterized in that the electrically conductive means of the first electrode is made from, or comprises, at least one material selected from the group comprising carbon, graphite, nickel or an alloy comprising nickel, steels and alloys comprising iron.

5. The energy conversion system as claimed in claim 1, characterized in that the electrically conductive means of the first electrode is self-supporting or non-self-supporting, the first electrode comprising a mechanical strength portion.

6. The energy conversion system as claimed in claim 1, characterized in that the electrically conductive means of the first electrode has the form of a filament, fiber, or point.

7. The energy conversion system as claimed in claim 1, characterized in that the assembly structure of the electrically conductive means of the first electrode is an unorganized bulk structure or an organized structure, in particular having the form of a sheet, plate, strip or coil.

8. The energy conversion system as claimed in claim 1, characterized in that the electrically conductive means of the first electrode is looped on itself in a closed circuit.

9. The energy conversion system as claimed in claim 1, characterized in that the electrically conductive means of the first electrode is not looped on itself and is in an open circuit.

10. The energy conversion system as claimed in claim 1, characterized by a first electrode and a second electrode having a symmetrical or pseudo-symmetrical structure.

11. The energy conversion system as claimed in claim 1, characterized by a first electrode and a second electrode having an asymmetrical structure.

12. An energy conversion device including an energy conversion system as claimed in claim 10, characterized in that it consists of a device for electrolysis, photolysis or electrosynthesis, for generating electricity by reverse electrolysis, for a fuel cell, an electric battery, or an ozone generator, or for electrodialysis.

13. An energy conversion device including an energy conversion system as claimed in claim 11, characterized in that it consists of a device such as a capacitor, discharge lamp, photovoltaic generator, solar cell with photoactive conductor.

14. (canceled)

15. An application of an elongate electrically conductive means having a length L greater than 1×10³ m (1 kilometer) and a radius of curvature R smaller than 40×10⁻⁶ m (40 microns) such that the L/R ratio is higher than 10⁶ (one million), for constituting a first electrode of an energy conversion system further comprising a second electrode and an inter-electrode gap comprising a functional medium, the first electrode generating, at the nanometric to millimetric scale, a significant increase in the electric field perceived by the second electrode, the inter-electrode gap having a thickness of between 1×10⁻⁹ m and 5×10⁻³ m (1 nanometer and 5 millimeters).

16. The application of the energy conversion system as claimed in claim 1 for producing nanometric to micrometric powders.

17. An energy conversion system, comprising a first electrode, a second electrode, and an inter-electrode gap therebetween that comprises a functional medium, the first electrode being made of at least one elongate electrically conductive means having a total length L, a curved cross section, and a radius of curvature R, and arranged in a sturdy assembly structure having a more or less open pattern, capable of having the same electrical potential at any location and thus of constituting said first electrode,
wherein:
R is smaller than 50×10⁻⁶ m (50 microns),
the inter-electrode gap has a thickness of between 1×10⁻⁹ m and 2×10⁻² m (1 nanometer and 2 centimeters), and
the L/R ratio is higher than 3×10⁶ (three million) such that the first electrode generates, at the nanometric to millimetric level, a significant increase in the electric field perceived by the second electrode.
